(19) United States
(12) Patent Application Publication
(10) Pub. No.: US 2011/0258429 A1
(43) Pub. Date: Oct. 20, 2011

(54) System and Method for Information Handling System Low Power Network Communications

(76) Inventors: Shun-Tang Hsu, Taiwan (TW); Dan Boice, Taiwan (TW)

(21) Appl. No.: 12/760,670

(22) Filed: Apr. 15, 2010

(51) Int. Cl. G06F 15/173; G06F 9/00; G06F 15/16; G06F 1/26

(52) U.S. Cl. 713/100; 709/224; 713/300; 709/204

(57) ABSTRACT

Low power monitoring of a social networking network location is supported by a wireless networking subsystem running on an information handling system in a reduced power state, such as with a powered down CPU. Instructions executing on the wireless networking subsystem periodically checks a social networking location and issues a notification at the information handling system if an event is detected, such as a new social networking posting. For example, the wireless networking subsystem presents social networking information at the display, or initiates presentation of social networking information by an embedded controller or a messaging operating system kernel having limited functionality that supports presentation of social networking information and limited power consumption.

### BACKGROUND OF THE INVENTION

1. Field of the Invention

The present invention relates in general to the field of information handling system network communications, and more particularly to a system and method for low power network communications.

2. Description of the Related Art

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Information handling systems are handy tools for staying in touch with social networks, such as through social network communities available through Facebook, Skype, Twitter and Plurk. Many end users have interactions with social networking sites throughout the day. For example, an end user gets a notification when a member of a social network updates the member's social networking site. The notification lets the end user know to check for updates at the social networking site so that the end user keeps up to date on social networking events. When an end user is interfaced with the Internet using an information handling system, the notifications allow end users a small diversion from other tasks in order to check content associated with the notification. One alternative for end users is to use a smart phone with an LCD screen to check on updates, however, smart phones tend to have limited functionality and small screens that make viewing content-intensive social networking sites difficult. A better alternative for end users is to use a portable information handling system. Portable information handling systems typically have functionality similar to that of desktop information handling systems, however, portable systems integrate I/O devices, such as a keyboard and display, and a power source, such as a battery, so that end users can use the system free from hard wire connections, such as to external peripherals or a power cord.

One difficulty with portable information handling systems is that leaving a system running only to monitor social networking sites tends to use a considerable amount of power, sometimes with little network interaction. Power consumption presents a concern with portable information handling systems because portable systems often operate on batteries that have a limited charge life. Although some smaller-sized and less powerful portable systems are available that consume relatively small amounts of power, end users often have more powerful systems that are used for work purposes, such as word processing, spreadsheets and presentations. For such systems, monitoring social networking sites is a relatively minor function that uses minimal amounts of available system processing power. End users would like to have the ability to monitor social networking sites without wastefully running a portable information handling system at its full capability.

### SUMMARY OF THE INVENTION

Therefore a need has arisen for a system and method which provides low power consumption network communications.

In accordance with the present invention, a system and method are provided which substantially reduce the disadvantages and problems associated with previous methods and systems for providing network communications for an information handling system. Logic executing on a wireless communications module monitors a network location through a wireless network for predetermined network activities while the information handling system is in a reduced power state, such as with a powered down processor. If a network event is detected, notification is provided at the information handling system of the network event, such as by illumination of an LED.

More specifically, an information handling system has plural processing components integrated in a housing, such as a processor, an embedded controller and a wireless communication module. A notification module included with the wireless communication module monitors one or more network locations for one or more network events and provides a notification of a detected network event for presentation to an end user. The notification module is, for instance, firmware stored in flash memory of the wireless communications module that executes on a processor of the wireless communications module when the information handling system main processor is powered off, such as in reduced power states. The notification module provides notice by illuminating an LED, by presenting a message at a display of the information handling system, or by signaling to the embedded controller. The embedded controller can issue notice to an end user and initiate a secondary operating system and browser so that the end user receives social networking information with a rapid system startup and minimal power consumption.

The present invention provides a number of important technical advantages. One example of an important technical advantage is that an end user gets network notifications when an information handling system is powered down. Monitoring for network notifications is performed with instructions executing on a network component of the information handling system, such as a wireless wide area network (WWAN) card. If a network event occurs, a notification issues at the information handling system, such as by illumination of an LED, so that an end user can check the network event at his convenience. End users stay up to date for social networking but reduce power consumption by an information handling system since minimal hardware and software functions are performed during monitoring. Rapid and low power updates are available by powering up an information handling system with limited functionality designed to obtain social networking information, such as an instant-on operating system and social networking kernel.

### BRIEF DESCRIPTION OF THE DRAWINGS

The present invention may be better understood, and its numerous objects, features and advantages made apparent to those skilled in the art by referencing the accompanying drawings. The use of the same reference number throughout the several figures designates a like or similar element.

FIG. 1 depicts a block diagram of an information handling system having a wireless communications module that provides low power monitoring of social networking activity; and

FIG. 2 depicts a flow diagram of a process for low power monitoring of social networking activity with an information handling system.

### DETAILED DESCRIPTION

Monitoring of social networking locations for events by a wireless communication module allows an information handling system to provide notifications of events from a reduced power state. For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, and a video display. The information handling system may also include one or more buses operable to transmit communications between the various hardware components.

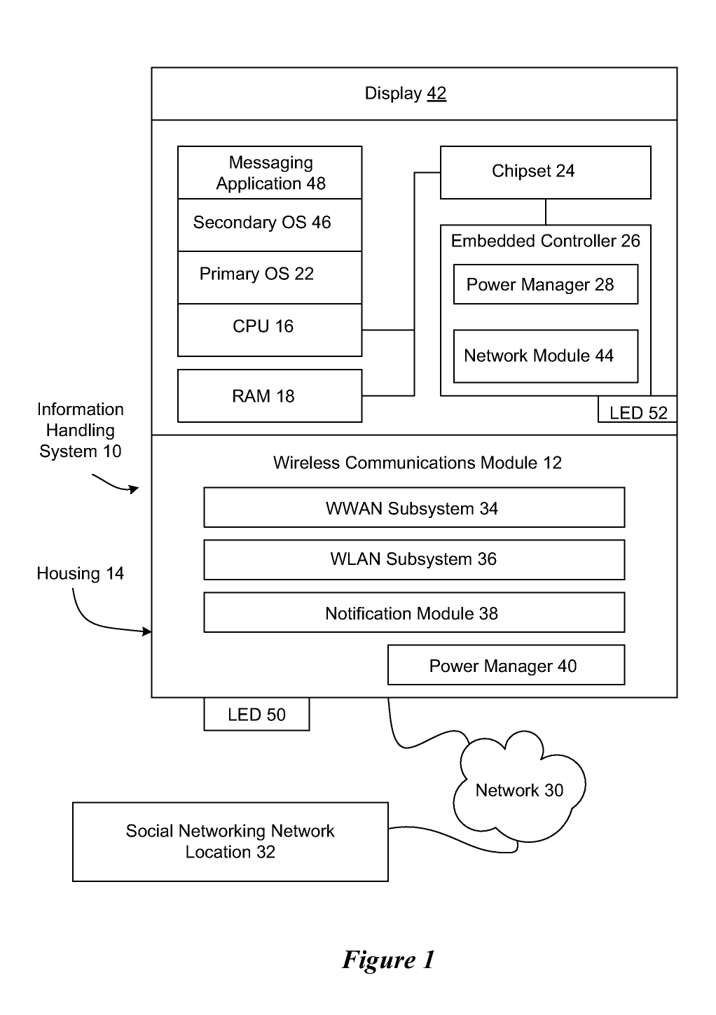

Referring now to FIG. 1, a block diagram depicts an information handling system 10 having a wireless communications module 12 that provides low power monitoring of social networking activity. Information handling system 10 processes information with plural processing components disposed in a housing 14. For example, a central processing unit (CPU) 16 performs instructions stored in random access memory (RAM) 18, such as instructions provided by permanent storage, such as a hard disk drive 20. For instance, a primary operating system 22 retrieved from hard disk drive 20 to RAM 18 provides instructions for execution on CPU 16 that supports execution of applications, such as word processing or Web browsing applications. A chipset 24 coordinates operation of processing components, such as with a BIOS or other firmware instructions stored in flash memory. An embedded controller 26 performs system management functions, such as accepting inputs from a keyboard and executing a power manager 28, which maintains a battery charge by managing power received from an external power source and power stored on an integrated battery. For example, power manager 28 employs ACPI reduced power states to lengthen battery life by powering down processing components when the components are not in active use and restoring the components to an on state when use is detected. In the S0 “on” state, the components operate normally. In the S3 “standby” or “sleep” reduced power state, CPU 16 is off and the operating state of the system is stored in RAM 18 for quick resume. In S4 “hibernation” reduced power state, the operating state is stored in hard disk drive 20 and RAM is powered off. In S5 “off” reduced power state, only components required to restart the system remain powered. For example, in each of the S3 and S4 reduced power states, embedded controller 26 typically remains powered up to initiate transition from the reduced power state to an on state when an end user makes an input at a keyboard or power switch.

Wireless communication module 12 supports network communications between information handling system 10 and a wireless network 30 to interact with network locations, such as a social networking network location 32. For example, wireless communication module 12 has a wireless wide area network (WWAN) subsystem 34 that supports communications through a WWAN, such as a cellular telephone network, and a wireless local area network (WLAN) subsystem 36 that supports communications through a WLAN, such as an IEEE 802.11(b, g or n) network. In essence, wireless communications module 12 is a smart phone integrated within information handling system 10's housing 14 to provide wireless data communications. For example, firmware instructions executing on a processor associated with WWAN subsystem 34 provides a degree of intelligence at wireless communications module 12 to perform functions other than wireless communications. For instance, a notification module 38 monitors network location 32 for predetermined network events and issues a notification of the event, such as with firmware instructions executing on a processor of WWAN subsystem 34. As another example, a power manager 40 powers up and down components within wireless communications module 12 in order to save power.

In operation, notification module 38 allows low power monitoring of network locations for predetermined network events. Power manager 28 of embedded controller 26 commands components within information handling system 10 to a reduced power state in which CPU 16 is powered off Notification module 38 detects the reduced power state and automatically initiates monitoring of social networking network location 32 for a social networking posting of interest, such as an update to an identified FACEBOOK page. Power manager 40 reduces power consumption by notification module 38 by periodically powering down wireless communications module 12 if no events are detected and periodically powering up wireless communications module 12 to update whether a predetermined event has been posted. Notification module 38 monitors network locations for network events of interest to an end user of information handling system 10 by storing the desired network locations and events in memory or wireless communication module 12. For instance, an end user can specify monitoring of messages posted by one or more identified FACEBOOK users or more specific content events, such as messages that includes pictures or videos. In alternative embodiments, notification module 38 monitors other types of network events, such as e-mails posted to a predetermined account or an update to a predetermined Web page. In one alternative embodiment, notification module 38 performs monitoring as a background service when CPU 16 is operating so that CPU 16 does not have to perform cycles to check on network events until notification is received from notification module 38.

Upon detection of a monitored network event, notification module 38 provides notification of detection of the event in a selected of plural manners. One notification option is to present the network event or information retrieved in response to the network event at a display 42 of information handling system 42. In a low power mode, wireless communication module 12 generates an image or text for presentation at display 42 and presents the image or text directly at display 42 with logic running on wireless communication module 12 so that other components of information handling system 10 can remain powered down. For example, display 42 includes a frame buffer that accepts text for presentation without graphics logic on wireless communication module 12, or that accepts a graphics display over a limit portion of the area of display 42 with a reduced use of backlights, such as LED backlights that support the limited display area. Essentially, smart phone logic on wireless communications module 12 operates to present information on a smart phone display area without a need to drive the entire display area, resulting in reduced power consumption. In an alternative embodiment, wireless communication module 12 presents information at display 42 with e-ink technology that consumes virtually no power unless a display presentation changes.

As an alternative to directly presenting information at display 42 with wireless communication module 12, notification module 38 sends a signal to embedded controller 26 to indicate detection of a network event. A network module 44, such as firmware executing on embedded controller 26, retrieves network information associated with the detected event and coordinates presentation of the network information at display 42. In one embodiment, network module 44 uses graphics logic within chipset 24 to present the network information so that other components of information handling system 10 remain in a reduced power state, such as CPU 16 remaining powered down. Alternatively, network module 44 initiates power up of CPU 16 so that network information is obtained and presented with components in a normal on operational state. In order to provide a more rapid wake-up and presentation of information, network module 44 initiates a secondary operating system 46 instead of primary operating system 22. Secondary operating system 46 includes more limited instructions that load and execute more quickly than primary operating system 22 so that a messaging application 48 rapidly obtains and presents network information at display 42. In one embodiment, in order to save further power, notification module 38 provides notification by illuminating an LED 50 with logic executing on wireless communication module 12. Alternatively, notification module 38 signals notification of a network event to network module 44 of embedded controller 26 to illuminate an LED 52. When LED 50 or 52 illuminates, an end user is provided with an indication of a network event, which the end user can retrieve by transitioning information handling system to an on state or by an input which allows notification module 38 or network module 44 to present the network event at display 42.

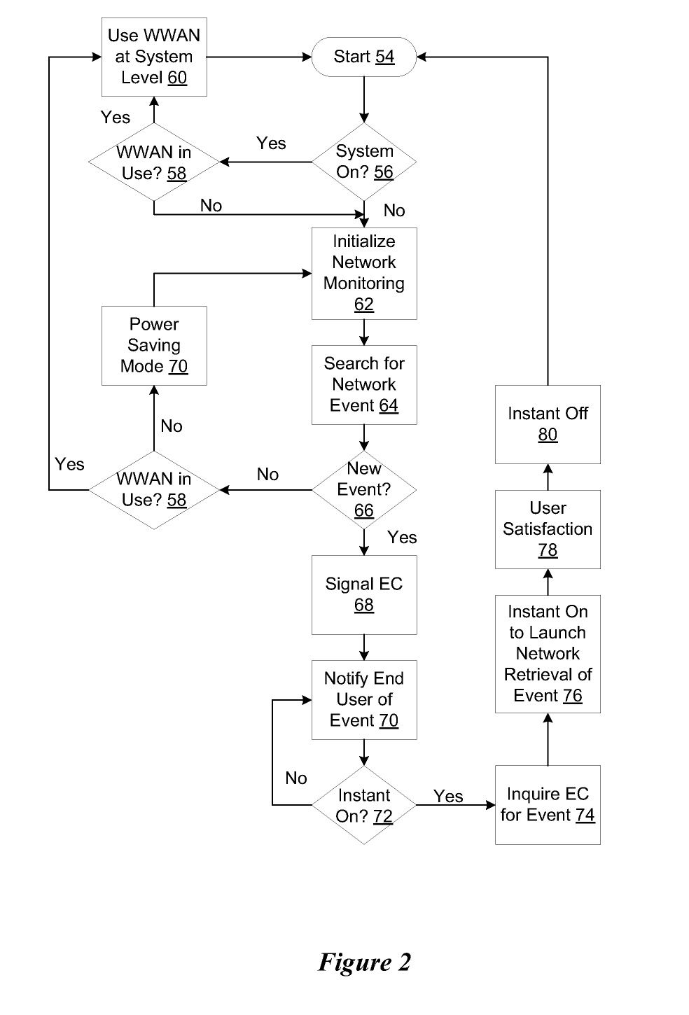

Referring now to FIG. 2, a flow diagram depicts a process for low power monitoring of social networking activity with an information handling system. The process starts at step 54 with initiation of social networking monitoring instructions at a WWAN communications module, such as firmware instructions executing on a processor integrate with a wireless network interface card. At step 56, a determination is made of whether the information handling system is in an on state or in a reduced power state. If the information handling system is in an on state, the process continues to step 58 to determine if the WWAN card is in use, such as by active browsing supported through the information handling system. If the WWAN card is in use, the process continues to step 60 to maintain the WWAN card in active use supported by the information handling system. If at step 58 the WWAN card is not in active use or at step 56 the information handling system is in a reduced power state, such as with a powered down CPU, the process continues to step 62 to initialize low power social networking monitoring on the WWAN card. At step 64, the WWAN card connects to a social network service to check for new social networking activities, such as new messages, photos or videos, based upon the predetermined network event selected by the end user for monitoring. If at step 66 no new activity is detected, the process continues to step 68 to determine if the information handling system needs the use of the WWAN card and, if so, the process continues to step 60. If at step 68 the information handling system does not need the WWAN card, the process continues to step 70 to suspend power consumption at the WWAN card, such as by powering down the processor of the WWAN card for a predetermined time period. After the power down time period passes, the process continues to step 62.

If at step 66 a new social networking activity is detected, the process continues to step 68 to inform the embedded controller of the detected activity. At step 70, the embedded controller informs the end user of the new activity, such as by illuminating an LED or presenting a reduced image at a display of the information handling system. At step 74, the end user can select an instant on button at the information handling system housing to initiate an operating system kernel and browser that enables a quick start and view of social networking content. If the end user does not select the button, the process returns to step 70 until a selection is made. While waiting to power up for full presentation of social networking information, the WWAN can power down to conserve energy. Once the end user selects to retrieve the social networking content at step 72, the process continues to step 74 at which the embedded controller inquires about the detected network activity or activities. At step 76, an instant on selection launches social networking widgets for rapid retrieval and presentation of social networking information. In one embodiment the embedded controller powers up only those components needed to obtain and present the social networking information in order to reduce system power consumption. At step 78 the end user engages in social networking until satisfied and, at step 80 the end user selects instant off to power down the system. The process returns to step 56 to determine whether to continue monitoring social networking with the WWAN card. In alternative embodiments, other types of network events are monitored and other types of networks may be used as set forth above.

Although the present invention has been described in detail, it should be understood that various changes, substitutions and alterations can be made hereto without departing from the spirit and scope of the invention as defined by the appended claims.

What is claimed is:

1. An information handling system comprising:
a processor operable to process information;
memory interfaced with the processor and operable to store information;
a wireless communication module interfaced with the processor and operable to communicate with a wireless network;
a embedded controller interfaced with the processor, the memory and the wireless communication module and operable to manage application of power to the processor, the memory and the wireless communication module; and
a notification module executing on the wireless communication module, the notification module operable to monitor the wireless network for a predetermined event with the processor in a powered down state and to issue a notification upon detection of the predetermined event.

2. The information handling system of claim 1 further comprising a light integrated with the wireless communication module, wherein the notification module issues a notification by illuminating the light upon detection of the predetermined event.

3. The information handling system of claim 1 wherein the notification module issues a notification to the embedded controller, the embedded controller further operable to provide the notification to an I/O device for presentation to an end user.

4. The information handling system of claim 1 wherein the notification module is further operable monitor the network by powering down with the processor in a powered down state, powering up at predetermined times to perform network monitoring, and powering down if a predetermined event is not detected after a predetermined time of performing network monitoring.

5. The information handling system of claim 1 wherein the notification module issues notification to the embedded controller, the embedded controller further operable to execute a networking module that presents the network event at an I/O device.

6. The information handling system of claim 5 wherein the networking module comprises firmware instructions executing on the embedded controller that retrieve information associated with the network event from the network and present the information at a display with the processor remaining in a powered down state.

7. The information handling system of claim 5 wherein the networking module comprises firmware instructions that power up the processor, the processor executing instructions that retrieve information associated with the network event from the network and present the information at a display.

8. The information handling system of claim 7 wherein the instructions executed by the processor comprise a secondary operating system kernel stored in memory that the networking module executes instead of a primary operating system.

9. The information handling system of claim 1 wherein the wireless communication module comprises a wireless wide area networking subsystem.

10. The information handling system of claim 1 wherein the wireless communication module comprises a wireless local area networking subsystem.

11. A method for monitoring a network for communications, the method comprising:
transitioning an information handling system from an on state to a reduced power state having a CPU of the information handling system powered off;
maintaining power in the reduced power state to a wireless network subsystem, the wireless network subsystem integrated in the information handling system;
monitoring a predetermined network location with instructions executing on the wireless network subsystem, the monitoring through a wireless network for a predetermined network event;
detecting the predetermined network event at the wireless network subsystem; and
issuing a notification from the wireless network subsystem in response to the detecting.

12. The method of claim 11 wherein the predetermined network event comprises a social networking posting made at a social networking network location.

13. The method of claim 11 wherein monitoring a predetermined network location further comprises periodically powering up the wireless network subsystem to communicate with the predetermined network location and powering down the wireless network subsystem.

14. The method of claim 11 wherein the wireless networking subsystem comprises a wireless wide area network subsystem operable to communicate through a cellular telephone network.

15. The method of claim 11 wherein the wireless networking subsystem comprises a wireless local area network subsystem operable to communicate through a wireless local area network.

16. The method of claim 11 wherein issuing a notification further comprises presenting a message at a display of the information handling system with instructions executing on the wireless networking subsystem and communicating directly with the display.

17. The method of claim 11 wherein issuing a notification further comprises:
sending a signal from the wireless networking subsystem to an embedded controller integrated in the information handling system; and
presenting a notification with the embedded controller.

18. The method of claim 17 wherein presenting a notification with the embedded controller further comprises illuminating a light at a housing of the information handling system.

19. The method of claim 17 wherein presenting a notification with the embedded controller further comprises presenting a message at a display of the information handling system with instructions executing on the embedded controller.

20. The method of claim 17 wherein presenting a notification with the embedded controller further comprises:
initiating the CPU with a secondary operating system separate from a primary operating system; and
executing a messaging application over the secondary operating system, the messaging application supporting interaction with the predetermined network location.
